(19) United States
(12) Patent Application Publication
(10) Pub. No.: US 2011/0164147 A1
(43) Pub. Date: Jul. 7, 2011

(54) IMAGING APPARATUS

(75) Inventors: Akihiko TAKAHASHI, Kawasaki-shi (JP); Shigemasa SATO, Yokohama-shi (JP)

(73) Assignee: NIKON CORPORATION, TOKYO (JP)

(21) Appl. No.: 12/888,840

(22) Filed: Sep. 23, 2010

(30) Foreign Application Priority Data
Oct. 2, 2009 (JP) 2009-230303
Sep. 21, 2010 (JP) 2010-210983

(51) Int. Cl. H04N 5/76

(52) U.S. Cl. 348/231.99; 348/E05.031

(57) ABSTRACT

An imaging apparatus includes: an instruction unit that issues a photographing instruction signal; an image sensor that obtains frame images over predetermined time intervals; a storage unit in which a plurality of the frame images obtained via the image sensor are sequentially stored; a save candidate determining unit that designates, among the plurality of the frame images stored in the storage unit, a plurality of the frame images obtained before and after an issue of the photographing instruction signal as candidates of images to be saved into a recording medium; and a candidate number determining unit that automatically determines, based upon specific information, a candidate number of the frame images that are to be designated as candidates by the save candidate determining unit.

### INCORPORATION BY REFERENCE

The disclosures of the following priority applications are herein incorporated by reference:
Japanese Patent Application No. 2009-230303 filed Oct. 2, 2009
Japanese Patent Application No. 2010-210983 filed Sep. 21, 2010

### BACKGROUND OF THE INVENTION

1. Field of the Invention

The present invention relates to an imaging apparatus.

2. Description of Related Art

Japanese Laid Open Patent Publication No. 2001-257976 discloses the following camera. Images photographed over predetermined time intervals following a first shutter release are sequentially stored into a buffer memory and, in response to a second shutter release, images in pre-frames having been photographed prior to the second shutter release (photographing instruction signal), an image in the frame corresponding to the second shutter release (photographing instruction signal) and images in post-frame photographed following the second shutter release (photographing instruction signal) among the stored images, are saved into a memory card.

### SUMMARY OF THE INVENTION

In the related art, the number of pre-frames (the number of frame images obtained before the photographing instruction signal is issued) and the ratio of the number of pre-frames and the number of post-frames (the number of frame images obtained after the photographing instruction signal is issued) are set in advance. However, a photographer, not knowing optimal values, may find it difficult to set a desirable ratio.

According to the 1st aspect of the present invention, an imaging apparatus comprises: an instruction unit that issues a photographing instruction signal; an image sensor that obtains frame images over predetermined time intervals; a storage unit in which a plurality of the frame images obtained via the image sensor are sequentially stored; a save candidate determining unit that designates, among the plurality of the frame images stored in the storage unit, a plurality of the frame images obtained before and after an issue of the photographing instruction signal as candidates of images to be saved into a recording medium; and a candidate number determining unit that automatically determines, based upon specific information, a candidate number of the frame images that are to be designated as candidates by the save candidate determining unit.

According to the 2nd aspect of the present invention, an imaging apparatus according to the 1st aspect may further comprise: an operation member that accepts an operation performed to select a specific frame image among the plurality of frame images designated as candidates of images to be saved, and the candidate number determining unit of the imaging apparatus may determine the candidate number of the frame images to be designated as candidates by using, as the specific information, a difference between time point at which the photographing instruction signal is received and time point at which the specific frame image is obtained.

According to the 3rd aspect of the present invention, it is preferred that in an imaging apparatus according to the 2nd aspect, the candidates of images to be saved are made up with A sheets of the frame images obtained before the issue of the photographing instruction signal and B sheets of the frame images obtained as and after the issue of the photographing instruction signal; the imaging apparatus further comprises a save unit in which history of the difference between the time point at which the photographing instruction signal is received and the time point at which the specific frame image is obtained is saved; and the candidate number determining unit determines the candidate number of the frame images obtained before the issue of the photographing instruction signal based upon an average value of timing differences indicated in the history saved in the save unit.

According to the 4th aspect of the present invention, the candidate number determining unit of an imaging apparatus according to the 2nd aspect may execute analysis to determine a photographic scene based upon the frame images obtained before the issue of the photographing instruction signal and determines the candidate number of the frame images to be designated as candidates in correspondence to each photographic scene indicated in analysis results used as the specific information.

According to the 5th aspect of the present invention, it is preferred that in an imaging apparatus according to the 1st aspect, the candidates of images to be saved are made up with A sheets of the frame images obtained before the issue of the photographing instruction signal and B sheets of the frame images obtained as and after the issue of the photographing instruction signal; and the candidate number determining unit ascertain frame-to-frame subject displacement based upon the A sheets of the frame images and reduces the candidate number so as to assume a smaller value as a sum of A and B in correspondence a smaller extent of the displacement indicated in displacement information used as the specific information.

According to the 6th aspect of the present invention, the candidate number determining unit of an imaging apparatus according to the 5th aspect may increase the candidate number so as to assume a greater value as the sum of A and B in correspondence to a greater extent of the frame-to-frame subject displacement.

According to the 7th aspect of the present invention, the candidate number determining unit of an imaging apparatus according to the 6th aspect may determine the candidate number so as to increase a ratio of A to the sum of A and B in correspondence to a greater extent of the frame-to-frame subject displacement.

According to the 8th aspect of the present invention, the candidate number determining unit of an imaging apparatus according to the 5th aspect may reduce the candidate number so as to assume an even smaller value as the sum of A and B in correspondence to a smaller extent of the frame-to-frame subject displacement, when a remaining capacity available at the storage unit is equal to or less than a predetermined value.

According to the 9th aspect of the present invention, an imaging apparatus according to the 2nd aspect may further comprise: a save unit in which history of the difference between the time point at which the photographing instruction signal is received and the time point at which the specific frame image is obtained is saved, and the candidate number determining unit of the imaging apparatus may determine the candidate number of the frame images based upon an average value and a variance value regarding the history saved in the save unit.

According to the 10th aspect of the present invention, an imaging apparatus according to the 9th aspect may further comprise: a decision-making unit that makes a decision as to whether a photographing operation is being executed by holding a focus-adjusted state in which focus is adjusted on a subject present over a specific distance from the imaging apparatus, and the candidate number determining unit of the imaging apparatus may adjust the candidate number of the frame images based upon results of the decision made by the decision-making unit.

According to the 11th aspect of the present invention, the candidate number determining unit of the 10th aspect may select a preset value for a candidate number instead of the candidate number of the frame images having been determined, when the decision-making unit decides that the photographing operation is being executed by holding the focus-adjusted state and a primary subject is not present within a focus area.

According to the 12th aspect of the present invention, an imaging apparatus according to the 9th aspect may further comprise: a grouping unit that divides values saved as the history in the save unit into groups, and the candidate number determining unit of the imaging apparatus may determine the candidate number of the frame images based upon an average value and a variance value regarding history belonging to a group having been formed via the grouping unit.

According to the 13th aspect of the present invention, an imaging apparatus according to the 12th aspect may further comprise: a velocity detection unit that detects a displacement velocity of a primary subject, and it is preferred that the grouping unit divides the history saved in the save unit into groups in correspondence to displacement velocities; and the candidate number determining unit determines the candidate number of the frame images based upon an average value and the variance value regarding the history belonging to a group corresponding to the displacement velocity.

The imaging apparatus according to the present invention makes it possible to set optimal values for the number of frame images that are to be obtained before an issue of a photographing instruction signal and the number of frame images that are to be obtained after the issue of the photographing instruction signal.

### BRIEF DESCRIPTION OF THE DRAWINGS

FIG. 1 is a block diagram showing the essential structure adopted in the electronic camera 1 achieved in an embodiment of the present invention.

FIG. 2 illustrates the time point at which images are obtained in a pre-capture photographing mode.

FIG. 3 presents a flowchart of the processing executed in the pre-capture photographing mode.

FIG. 4 presents a flowchart of initial value learning processing.

FIG. 5 presents a flowchart of the learning processing executed in a second embodiment.

FIG. 6 is a diagram presenting examples of a Δd distribution and an average value.

FIG. 7 is a diagram in reference to which variation 4 will be described.

FIG. 8 is a diagram presenting an example of the special value C.

### DESCRIPTION OF PREFERRED EMBODIMENTS

The following is a description of the embodiments of the present invention given in reference to the drawings.

### First Embodiment

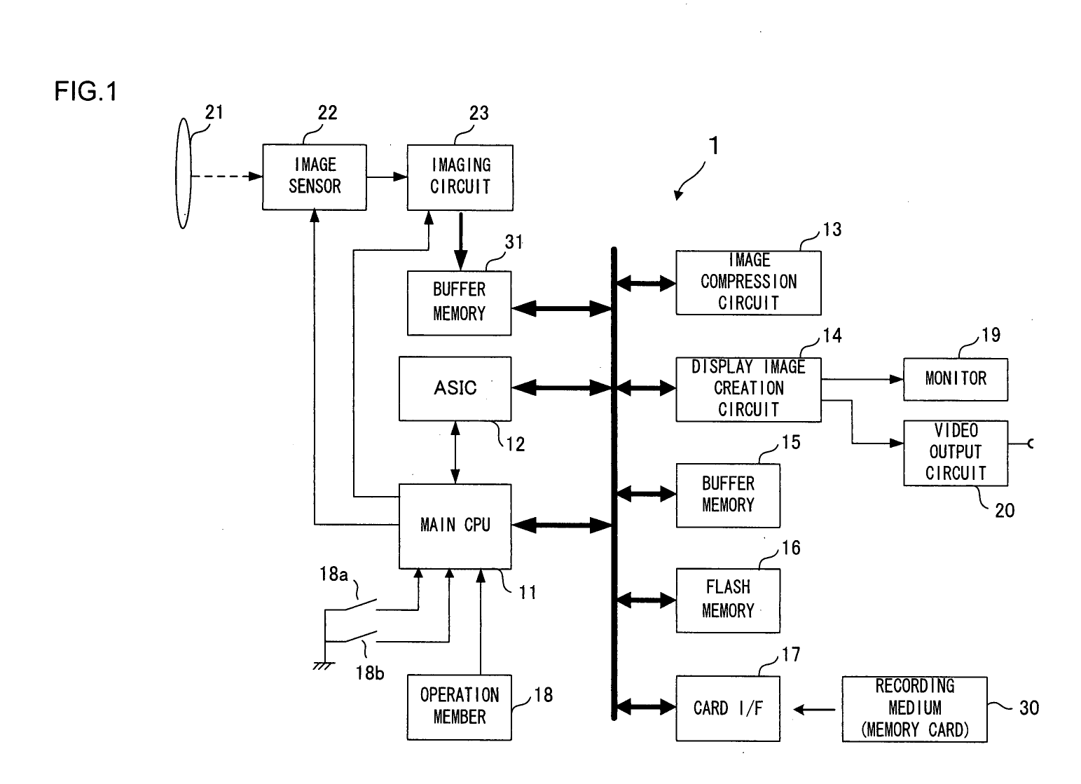

FIG. 1 is a block diagram showing the essential components constituting an electronic camera 1 achieved in the embodiment of the present tension. The electronic camera 1 is controlled by a main CPU 11.

A subject image is formed through a photographic lens 21 onto an image-capturing surface of an image sensor 22. The image sensor 22, which may be constituted with a CCD image sensor or a CMOS image sensor, outputs imaging signals obtained by capturing the subject image formed on the image-capturing surface, to an image-capturing circuit 23. The image-capturing circuit 23 executes analog processing (such as gain control) on the photoelectric conversion signals output from the image sensor 22 and also converts the analog image-capturing signals to digital data at a built-in A/D conversion circuit.

The main CPU 11 executes predetermined arithmetic operations by using signals input thereto from various blocks and outputs control signals, which are generated based upon the arithmetic operation results, to the individual blocks. The digital data that has been undergone the A/D conversion is temporarily stored at the buffer memory 31. In the buffer memory 31, a predetermined memory capacity for storing image data corresponding to at least one hundred frame images is allocated. The buffer memory 31 in the embodiment is used when temporarily storing pre-captured images obtained at the image sensor 22 at a predetermined frame rate before a photographing instruction is issued (before the shutter release button is pressed all the way down). The “pre-captured” images are to be described in detail later.

An image processing circuit 12, which may be constituted with, for instance, an ASIC, executes image processing on the digital imaging signals input thereto from the buffer memory 31. The image processing executed at the image processing circuit 12 includes, for instance, edge enhancement processing, color temperature adjustment (white balance adjustment) processing and format conversion processing executed on the imaging signals.

An image compression circuit 13 executes image compression processing so as to compress the imaging signals having undergone the processing at the image processing circuit 12 into, for instance, the JPEG format at a predetermined compression rate. A display image creation circuit 14 generates display signals to be used when displaying the captured image at a liquid crystal monitor 19.

At the liquid crystal monitor 19, constituted with a liquid crystal panel, an image and an operation menu screen or the like is brought up on display based upon display signals input thereto from the display image creation circuit 14. An image output circuit 20 generates, based upon the display signals input thereto from the display image creation circuit 14, display signals that will enable an external display device to display an image, an operation menu screen or the like, and outputs the display signals thus generated.

A buffer memory 15, where data yet to undergo the image processing, data having undergone the image processing and data currently undergoing the image processing are temporarily stored, is also used to store an image file yet to be recorded into a recording medium 30 or an image file having been read out from the recording medium 30. The buffer memory 15 in the embodiment is also used when temporarily storing pre-captured images obtained at the image sensor 22 at a predetermined frame rate before the photographing instruction is issued (before the shutter release button is pressed all the way down). The “pre-captured” images are to be described in detail later.

In a flash memory 16, a program executed by the main CPU 11, data needed when the main CPU 11 executes processing and the like are stored. The content of the program or the data stored in the flash memory 16 can be supplemented or modified based upon an instruction issued by the main CPU 11.

A card interface (I/F) 17 includes a connector (not shown) at which the storage medium 30 such as a memory card is connected. In response to an instruction issued by the main CPU 11, data can be written into the connected recording medium 30 or data in the connected recording medium 30 can be read out at the card interface 17. The recording medium 30 may be constituted with a memory card having a built-in semiconductor memory or a hard disk drive.

An operation member 18, which includes various buttons and switches at the electronic camera 1, outputs an operation signal corresponding to operational details of an operation performed at a specific button or switch constituting the operation member, such as a switching operation at a mode selector switch, to the main CPU 11. A halfway press switch 18a and a full press switch 18b each output an ON signal to the main CPU 11 by interlocking with depression of the shutter release button (not shown). The ON signal (halfway press operation signal) is output from the halfway press switch 18a as the shutter release button is depressed to a point roughly halfway through the full travel of the shutter release button and the ON signal output is cleared once the shutter release button held halfway down is released. The ON signal (full press operation signal) is output from the full press switch 18b as the shutter release button is depressed through the full travel of the shutter release button and the ON signal output is cleared once the shutter release button held all the way down is released. The halfway press operation signal constitutes an instruction for the main CPU 11 to start preparing for a photographing operation. The full press operation signal constitutes an instruction for the main CPU 11 to start obtaining an image to be recorded.

(Photographing Modes)

The electronic camera 1 may assume a regular photographing mode or a pre-capture photographing mode. The electronic camera 1 set in the regular photographing mode obtains a single photographic image each time a full press operation signal is output and records the photographic image into the recording medium 30. The electronic camera 1 set in the pre-capture photographing mode, on the other hand, obtains a plurality of consecutive photographic still images at a rate of 120 frames/second (120 FPS) at a high shutter speed (e.g., higher than 1/125 seconds) in response to the halfway press operation signal. Then, upon receiving the full press operation signal, the electronic camera 1 in the pre-capture photographing mode records predetermined numbers of frame images, captured before and after the reception of the full press operation signal, into the recording medium 30. One photographing mode can be switched to the other in response to an operation signal output from the operation member 18.

(Reproduction Mode)

The electronic camera 1 in the reproduction mode is able to reproduce and display at the liquid crystal monitor 19 a single image or a predetermined number of images having been recorded in either of the photographing modes described above.

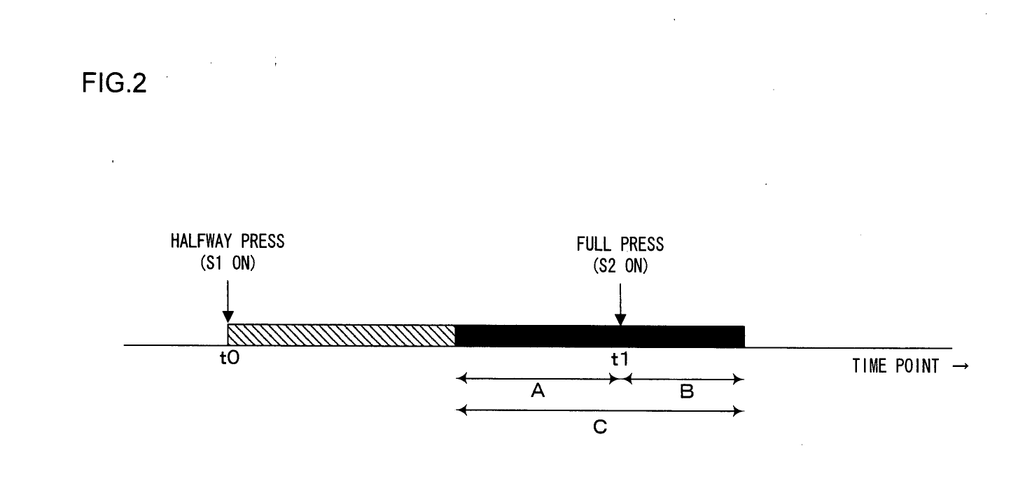

Since the pre-capture photographing mode is a feature characterizing the embodiment, the following explanation focuses on the operation executed in the pre-capture photographing mode. FIG. 2 illustrates the timing with which images are obtained in the pre-capture photographing mode.

(Pre-Capture Photographing Operation Executed Under Normal Circumstances)

As a halfway press operation signal is input at a time point t0 in FIG. 2, the main CPU 11 starts shutter release standby processing. During the shutter release standby processing, the main CPU 11 executes exposure calculation and focus adjustment by capturing the subject images at a frame rate of, for instance, 120 frames/second (120 FPS) and stores the image data thus obtained sequentially into the buffer memory 31.

The predetermined memory capacity indicating the memory space available in the buffer memory 31 for the pre-capture photographing operation is allocated in advance.

If the number of frame images (pre-capture images) stored into the buffer memory 31 following the time point t0 reaches a predetermined value and the memory space taken up by these frame images exceeds the predetermined memory capacity, the main CPU 11 deletes older frame images by writing a new frame image over the oldest frame image. Through these measures, the memory space in the buffer memory 31 used for the pre-capture photographing operation can be controlled to match the predetermined capacity allocation.

As a full press operation signal is input at a time point t1, the main CPU 11 starts shutter release processing. During the shutter release processing, the main CPU 11 individually records A sheets of frame images (pre-capture images) having been captured prior to the time point t1 and B sheets of frame images (post-capture images) captured following the time point t1 into the recording medium 30 by correlating the frame images captured prior to and following the time point t1.

The value A corresponds to the numbers of pre-capture images and the value B corresponds to the numbers of post pre-capture images. The filled bar in FIG. 2 represents the period of time over which the (A+B) sheets of frame images to be recorded into the recording medium 30 are obtained. The hatched bar represents the period of time over which frame images that are first stored into the buffer memory 31 but are subsequently deleted through overwrite, are obtained.

It is to be noted that either a first recording method or a second recording method, selected in response to an operation signal from the operation member 18, may be adopted when recording frame images. When the first recording method is selected, the main CPU 11 records all the (A+B) sheets of frame images into the recording medium 30. In the second recording method, on the other hand, the main CPU 11 records only a specific frame image indicated by the user, among the(A+B) sheets of frame images, into the recording medium 30. The embodiment is described by assuming that the second recording method has been selected.

In the second recording method, the main CPU 11 brings up on display at the liquid crystal monitor 19 a single frame image at a time or a predetermined number of frame images (e.g., four frame images) at a time among the (A+B) sheets of frame images before recording any of the frame images into the recording medium 30. Then, the main CPU 11 records only a specific frame image selected via an operation signal output from the operation member 18 into the recording medium 30. The filled bar in the timing chart of the operation executed by adopting the second recording method will represent the period of time over which the (A+B) sheets of frame images, i.e., save candidates, any of which may be recorded into the recording medium 30, are obtained.

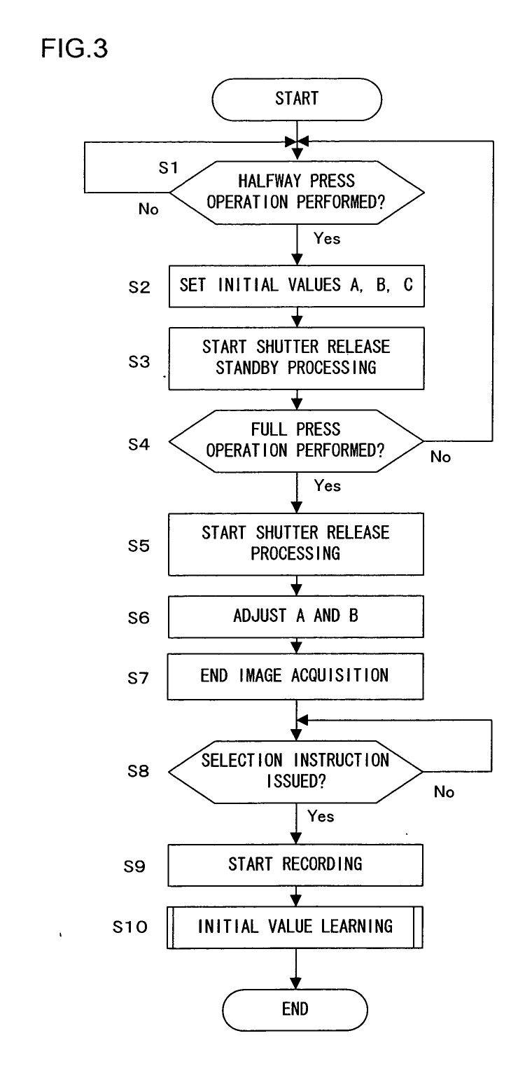

The values to be set for A and B mentioned above are automatically selected in the electronic camera 1 as described below. FIG. 3 presents a flowchart of the processing executed by the main CPU 11. The main CPU 11 repeatedly executes the processing in FIG. 3 while the camera is set in the pre-capture photographing mode. In step S1 in FIG. 3, the main CPU 11 makes a decision as to whether or not a halfway press operation has been performed. The main CPU 11 makes an affirmative decision in step S1 if a halfway press operation signal from the halfway press switch 18a has been input and, in this case, the operation proceeds to step S2. However, if no halfway press operation signal from the halfway press switch 18a has been input, the main CPU 11 makes a negative decision in step S1 and waits for an input of a halfway press operation signal.

In step S2, the main CPU 11 sets initial values for A, B and C and then the operation proceeds to step S3. In step S3, the main CPU 11 starts the shutter release standby processing described earlier before proceeding to step S4. In step S4, the main CPU 11 makes a decision as to whether or not a full press operation has been performed. The main CPU 11 makes an affirmative decision in step S4 if a full press operation signal from the full press switch 18b has been input and, in this case, the operation proceeds to step S5. However, if no full press operation signal from the full press switch 18a has been input, the main CPU 11 makes a negative decision in step S4 and the operation returns to step S1.

In step S5, the main CPU 11 starts the shutter release processing described earlier before proceeding to step S6. In step S6, the main CPU 11 adjusts the values for A and B, and then the operation proceeds to step S7. In more specific terms, the main CPU 11 determines a motion vector as known in the related art based upon the number of frame images (pre-capture images) having been stored into the buffer memory 31 before making the affirmative decision in step S4. If the motion vector is smaller, the main CPU 11 decreases at least either A or B so that the sum (A+B) assumes a smaller value. If, on the other hand, the motion vector is larger, the main CPU increases at least A so that the sum (A+B) assumes a larger value.

The main CPU 11 ends the image acquisition in step S7 before proceeding to step S8. In step S8, the main CPU 11 accepts an operation for selecting an image among the (A+B) frame images, to be recorded into the recording medium 30. If an operation signal indicating a frame image to be recorded has been input via the operation member 18, the main CPU 11 makes an affirmative decision in step S8 and the operation proceeds to step S9. However, if no operation signal indicating a frame image to be recorded has been input via the operation member 18, a negative decision is made in step S8 and the operation waits for a selection operation to be performed.

In step S9, the main CPU 11 records the selected frame image into the recording medium 30 and then the operation proceeds to step S10. In step S10, the main CPU 11 executes initial value learning processing for the next processing session, before ending the processing shown in FIG. 3.

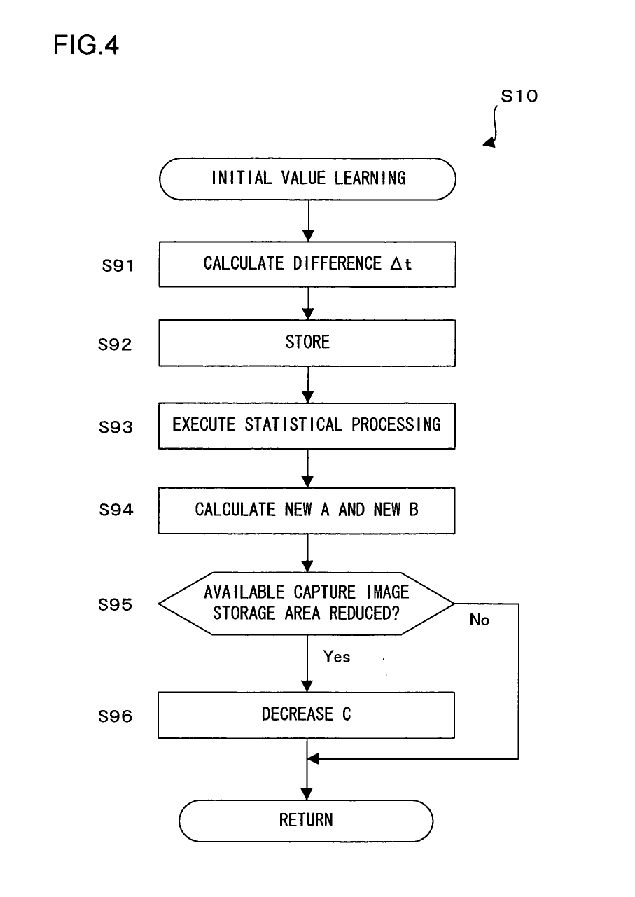

In the initial value learning processing, the initial value A is reevaluated based upon the time difference Δt between the time point at which the frame selected in step S8 was obtained and the time point at which the full press operation signal from the full press switch 18b was input. The flow of the initial value learning processing is now described in reference to the flowchart presented in FIG. 4.

In step S91 in FIG. 4, the main CPU 11 calculates Δt (the difference between the time point at which the selected frame was obtained and the time point at which the full press operation signal was received), and then the operation proceeds to step S92. In step S92, the main CPU 11 stores Δt into the flash memory 16, before proceeding to step S93.

In step S93, the main CPU 11 executes statistical processing of the known art by using the history of Δt stored in the flash memory 16, and then the operation proceeds to step S94. In step S94, the main CPU 11 calculates a new A value and a new B value before proceeding to step S95. In more specific terms, it excludes any unusual value assumed for Δt based upon the results of the statistical processing executed in step S93 and calculates an average value Δtm of the values calculated for Δt other than excluded unusual values. The main CPU 11 then designates the value obtained by multiplying the average value Δtm by 1.5 as a post-learning processing initial value A (new A=1.5×Δtm). In addition, the main CPU 11 designates the value obtained by subtracting the new A from the initial value C as an updated initial value B (new B=initial value C−new A).

In the embodiment, the initial value A, the initial value B and the initial value C are determined in advance as described below. It is known that while there is a tendency among photographers to perform shutter release operations slightly early, there are also many photographers who tend to perform shutter release operations slightly late relative to the optimal shutter release timing. Test data collected from a considerable number of subjects indicate that the extent by which the actual shutter release is performed prematurely by the photographer, ahead of the intended moment, is usually up to 0.3 seconds. The data also indicate that the delay with which the actual shutter release operation is delayed by the photographer, after the intended moment, is usually up to approximately 0.4 seconds Accordingly, the number of frames of images A to be obtained before the photographing instruction signal is issued is set greater than the number of frames of images B to be obtained after the photographing instruction signal is issued so as to improve the probability that the image captured at the intended instant is included in the recording candidate images.

In more specific terms, the initial value A is set so as to represent the number of frames of images to be obtained over the 0.4-second period mentioned above (48 images at 120 fps), the initial value B is set so as to represent the number of frames to be obtained over the 0.3-second period (36 images at 120 fps) and the sum of the initial values A and B is set as the initial value C (=initial value A+initial value B).

In step S95, the main CPU 11 makes an affirmative decision if the remaining capacity of the buffer memory 31 representing the available memory space for temporarily storing pre-capture images is less than a predetermined capacity, i.e., if the motion vector determined in step S6 is equal to or less than a predetermined value, and the operation proceeds to step S96 upon making the affirmative decision. However, the main CPU 11 makes a negative decision in step S95 if the motion vector determined in step S6 exceeds the predetermined value, and ends the processing in FIG. 4 in such a case. Upon making a negative decision in step S95, the main CPU 11 ends the processing in FIG. 4 without altering the value set as the initial value C.

In step S96, the main CPU 11 decreases at least either the new A value or the new B value so as to set a smaller value for C (=new A+new B) with a greater difference relative to the initial value C in correspondence to a smaller value representing the motion vector. Upon completing step S96, it ends the processing in FIG. 4. In other words, after making an affirmative decision in step S95, the main CPU adjusts the initial value C to a smaller value before ending the processing in FIG. 4.

The following advantages are achieved through the first embodiment described above.

(1) The electronic camera 1 includes the image sensor 22, which obtains frames of images over predetermined time intervals, the buffer memory 31 into which a plurality of frame images obtained via the image sensor 22 are sequentially stored and the main CPU 11, which issues a photographing instruction signal, designates a plurality of frame images obtained before and after the photographing instruction signal is issued, among a plurality of frame images stored in the buffer memory 31, as candidate images to be saved into the recording medium 30 and automatically determines the number of frame images to be designated as candidates based upon specific information. This structure allows optimal values to be set as the number of frame images to be obtained before the photographing instruction signal is issued and the number of frame images to be obtained after the photographing instruction signal is issued, which, in turn, makes it possible to reduce the memory space in the buffer memory 31 used for frame image storage and also reduce the length of time required to transfer/record an image into the recording medium 30.

(2) The electronic camera 1 further includes the operation member 18 functioning as an interface at which an operation performed in order to select a specific frame image among the plurality of frame images designated as the save candidates is accepted. The main CPU 11 determines the number of frame images to be designated as save candidates by using specific information indicating the time difference between the time point at which the photographing instruction signal was received and the time point at which the specific frame image is obtained. The optimal number of frame images to be saved can be set by, for instance, adjusting the number of candidates in correspondence to the value indicating the difference.

(3) The save candidates described in (2) is made up with A sheets of the frame images having been obtained before the photographing instruction signal is issued and B sheets of the frame images obtained at the time of, and after the photographing instruction signal is issued. The electronic camera 1 further includes the flash memory 16, in which the history of the difference between the time point at which the photographing instruction signal is received and the time point at which the specific frame image is obtained, is saved. When determining the number of save candidates, the main CPU 11 determines the number of frame images, among the frame images obtained before the photographing instruction signal is issued, to be designated as save candidates based upon the time difference average value calculated based upon the history saved in the flash memory 16. The main CPU 11 is thus able to set an optimal number of frame images by, for instance, adjusting the number of save candidates in correspondence to the average value.

(4) When the main CPU 11 determines the number of candidates as described in (3) above, it analyzes the photographic scene based upon frame images obtained before the photographing instruction signal is issued and determines the number of frame images to be designated as candidates in correspondence to each type of photographic scene indicated by the analysis results used as the specific information. For instance, the number of candidates may be increased when photographing a dynamic subject or the number of candidates may be reduced if the subject is not moving, so as to set an optimal number of frame images.

(5) Save candidates may be made up with A sheets of the frame images obtained before the photographing instruction signal is issued and B sheets of the frame images obtained after the photographing instruction signal is issued. Under such circumstances, the main CPU 11, which determines the number of candidates ascertains the frame-to-frame subject displacement based upon the A sheets of the frame images and reduces the number of candidates so as to set a smaller value as the sum of A and B in correspondence to a smaller extent of displacement indicated in the subject displacement information used as the specific information. As a result, an optimal value can be set as the number of frame images.

(6) When determining the number of candidates as described in (5) above, the main CPU 11 increases the number of candidates by so as to set a greater value as the sum of A sheets and B sheets in correspondence to a greater extent of frame-to-frame subject displacement and thus, is able to set an optimal number of frame images for saving.

(7) When determining the number of candidates, as described in (6) above, the main CPU 11 determines the number of candidates so as to allow A sheets to achieve a greater ratio to the sum of A sheets and B sheets if the extent of frame-to-frame displacement is greater, and is thus able to set an optimal number of frame images for saving.

(8) When the remaining capacity at the buffer memory 31 is equal to or less than a predetermined value, the main CPU 11, which determines the number of candidates as described in (5) or (6) above, reduces the number of candidates so as to set an even smaller value as the sum of A sheets and B sheets in relation to a smaller extent of frame-to-frame subject displacement. As a result, an optimal number of frame images to be saved can be set by factoring in the remaining capacity at the buffer memory 31, as well.

(Variation 1)

The following rationale is assumed in the first embodiment described above, in which pre-capture images yet to undergo the image processing are stored into the buffer memory 31 and post-capture images are stored into the buffer memory 15 after undergoing the image processing at the image processing circuit 12. Namely, older frame images stored as pre-capture images may become erased through overwrite, as described earlier, and thus, by storing the pre-capture images before they undergo the image processing, it is ensured that no image processing will have been executed wastefully in the event of an overwrite erasure. However, as long as the processing onus on the image processing circuit 12 remains light and the power consumption at the image processing circuit 12 remains insignificant, the present invention may be adopted in a structure that does not include the buffer memory 31, i.e., a structure in which the pre-capture images and the post-capture images are stored into the buffer memory 15 after undergoing the image processing at the image processing circuit 12.

(Variation 2)

In the description of the first embodiment provided above, the value A taken for the number of frame images obtained as pre-capture images and the value B taken for the number of frame images obtained as post-capture images represent the memory space used in the pre-capture photographing mode (the memory space in the buffer memory 31 where the pre-capture images are stored and the memory space in the buffer memory 15 where the post-capture images are stored). As an alternative, the memory space used in the pre-capture photographing mode may be represented by the memory capacity requirement. In such a case, the required memory capacity can be calculated by multiplying the data size of a single frame image by the number of frame images.

(Variation 3)

The initial values A, B and C may be grouped in correspondence to various categories. The main CPU 11 in variation 3 categorizes a sequence of photographic images as a specific photographic scene such as a portrait or a sport scene through photographic scene analysis of the known art executed based upon the pre-capture images or the post-capture images. Then, when adjusting the A value and the B value in step S6, as described earlier, and when executing the initial value learning processing in step S9, as described earlier, the main CPU 11 determines the values for A, B and C in correspondence to the photographic scene category having been ascertained. For instance, if the images have been categorized as a sport scene, the sports scene will be further analyzed and the images will be labeled with a more specific category such as ball game, track and field, auto racing or the like. By labeling the photographic scene with a specific category and selecting optimal values for A, B and C in correspondence to the photographic scene category, optimal values can be set for the number of pre-frames and the number of post-frames.

### Second Embodiment

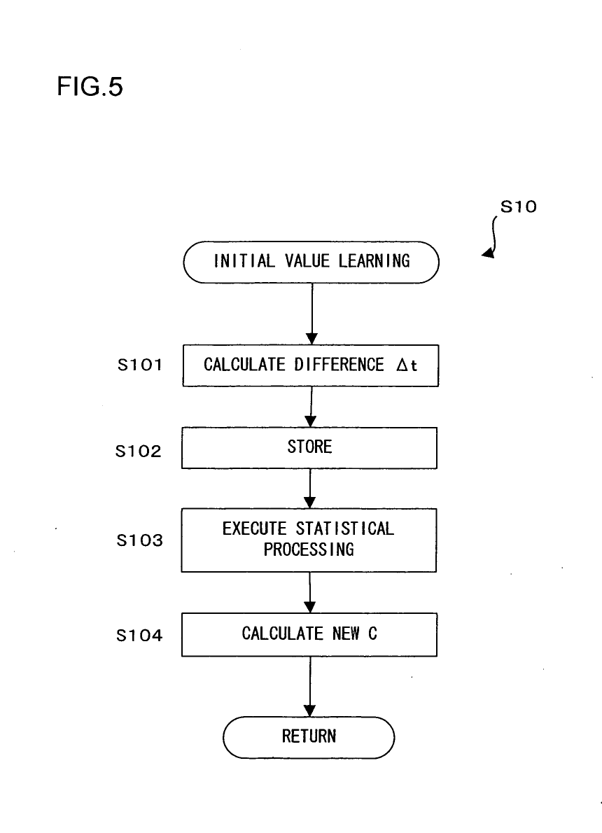

The initial value C is reevaluated in the second embodiment based upon the time difference Δt between the time point at which the frame image selected in step S8 (see FIG. 3) was obtained and the time point at which the full press operation signal originating from the full press switch 18b was input. In reference to the flowchart presented in FIG. 5, the flow of the initial value learning processing executed by the main CPU 11 in the second embodiment is described. The processing in FIG. 5 is executed in place of the processing executed in the first embodiment, as shown in FIG. 4.

In step S101 in FIG. 5, the main CPU 11 calculates Δt (the difference between the time point at which the selected frame was obtained and the time point at which the full press operation signal was received), and then the operation proceeds to step S102. In step S102, the main CPU 11 stores Δt into the flash memory 16, before proceeding to step S103.

In step S103, the main CPU 11 executes statistical processing of the known art by using the history of Δt stored the flash memory 16, and then the operation proceeds to step S104. In step S104, the main CPU 11 calculates a new value for C, as described below, before ending the processing in FIG. 5.

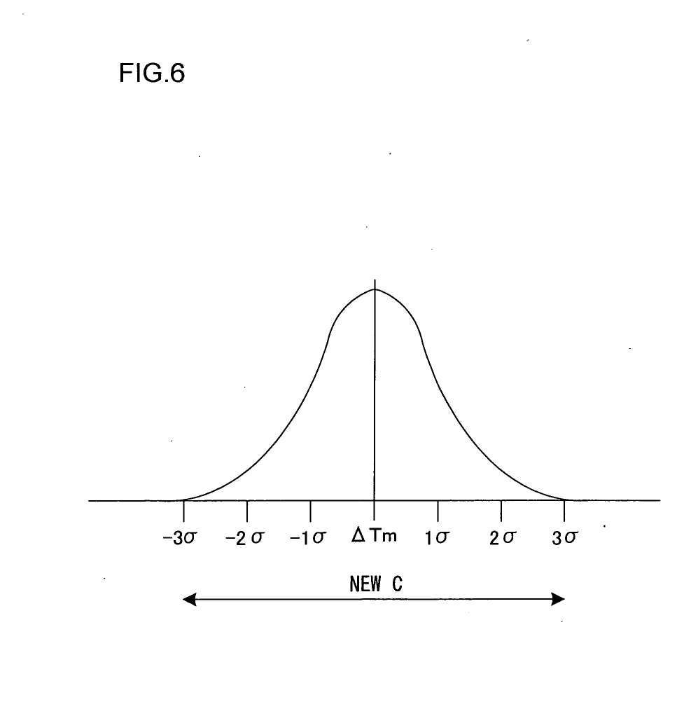

In the second embodiment, the main CPU 11 calculates the average value ΔTm of all the Δt values stored in the flash memory 16, as shown in FIG. 6. FIG. 6 is a diagram presenting examples of a Δt distribution and an average value. The main CPU 11 then sets the C value by designating the range defined by −3σ to the left of the average value ΔTm and +3σ to the right of the average value ΔTm as a new C value. As expressions (1) and (2) below indicate, σ, which represents the standard deviation of the Δt distribution, is equivalent to a positive square root of the variance (sample variance) σ².

average value ΔTm=(1/n) Σ (xi) . . . (1) when i=1, 2, . . . n

variance σ² =(1/n) Σ (xi−ΔTm)² . . . (2) when i=1, 2, . . . n

It is statistically substantiated that the new C value includes 99.7% of the Δt values stored in the flash memory 16. The main CPU 11 calculates new values for A and B in correspondence to the new C value based upon the most recently calculated Δt value. For instance, if the most recently calculated Δt value is substantially equal to ΔTm, new A=new B=new C/2. The main CPU 11 uses the new A value, the new B value and the new C value as the initial values to be set in step S2 (see FIG. 3) in the next session of pre-capture photographing processing.

Through the second embodiment described above, C, representing the sum of the number of frame images A obtained before the photographing instruction signal is issued and the number of frame images B obtained after the photographing instruction signal is issued, can be automatically set to an optimal value based upon the difference Δt between the time point at which the selected frame is obtained and the time point at which the photographing instruction signal is input (S2 ON timing). In addition, the number of frame images C is set by factoring in the history of the time point at which the electronic camera has been previously operated by the user. Thus, an unnecessarily large value will not be set for the number of frame images C, which, in turn, makes it possible to minimize the memory space used in the buffer memory and reduce the length of time required when transferring/recording an image into the recording medium 30.

(Variation 4)

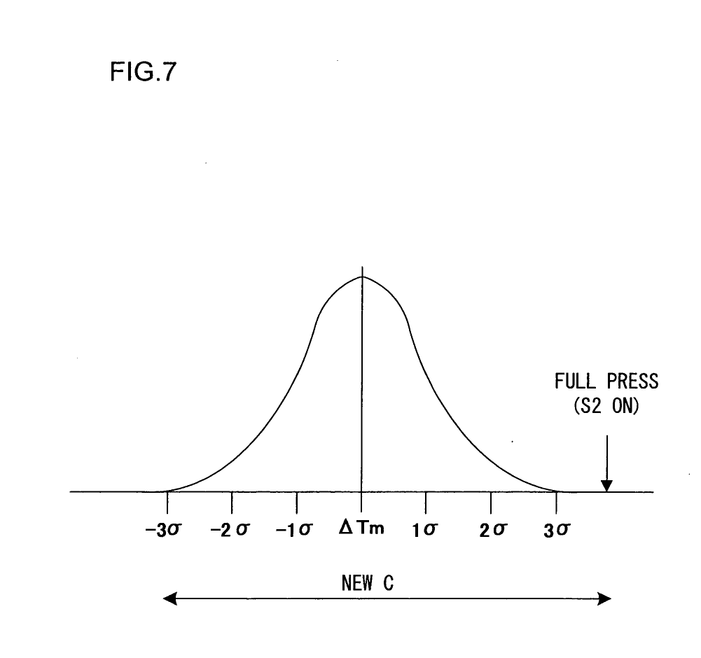

In the second embodiment described above, the new C value is set so as to match the range (±3σ) that statistically includes 99.7% of the Δt values. However, if the most recently calculated Δt is not within the ±3σ range, the new C value may be calculated so that the range includes the most recently calculated Δt. FIG. 7 is a diagram pertaining to variation 4. In reference to FIG. 7, an example in which a value calculated for Δt is beyond +3σ to the right of the average value ΔTm is described. In this case, the main CPU 11 will update the C value by designating a combined range that includes the range between the average value ΔTm and the |S2 on−ΔTm| range to the right of the average value ΔTm as a new C value. The S2 ON timing is the time point at which the photographing instruction signal is issued. In variation 4, the new C value calculated by taking into consideration the entire Δt history can be set as the initial value for C in step S2 (see FIG. 3) in the next session of pre-capture photographing processing.

### Third Embodiment

In reference to the third embodiment, an arithmetic operation executed to calculate a new C value when the electronic camera is in a focus-locked state is described. In the focus-locked state, the camera is held (locked) in a condition in which it is pre-focused on a subject present over a specific distance from the camera. In the third embodiment, the main CPU 11 accepts a full press operation (in step S4 in FIG. 3) in the focus-locked state.

Unless the electronic camera is in the focus-locked state, the main CPU 11 will normally adjust focus by driving the focusing lens immediately before starting the shutter release processing in step S5 (see FIG. 3). The CPU 11 in the electronic camera in the focus-locked state, on the other hand, executes the shutter release processing in step S5 (see FIG. 3) while holding (locking) the camera in the focused state.

Accordingly, the main CPU 11 in the third embodiment calculates the C value to be set as the initial value in step S2 (see FIG. 3) through either type of arithmetic operations different from each other depending upon whether or not the electronic camera is in the focus-locked state. More specifically, unless the electronic camera is in the focus-locked state, the main CPU 11 calculates new values for A, B and C through arithmetic operation similar to that in the second embodiment described earlier and the new A value, the new B value and the new C value thus calculated are then used as the initial values to be set in step S2 (see FIG. 3) in the next session of pre-capture photographing processing.

The main CPU 11 in the electronic camera in the focus-locked state, on the other hand, fine-adjusts the type of processing to be executed depending upon whether or not the primary photographic subject is present within the focusing target area (also referred to as a focus area or a focus frame) within the photographic image plane.

When the focus lock is on and the primary photographic subject is present in the focus area (or the focus frame, hereafter the term “focus area” may be substituted with the term “focus frame”) within the photographic image plane, the main CPU 11 calculates new values for A, B and C, as in the second embodiment described earlier, and uses the new A value, the new B value and the new C value thus calculated as the initial values to be set in step S2 (see FIG. 3) in the next session of pre-capture photographing processing.

When the focus lock is on and the primary subject is not present in the focus area within the photographic image plane, the main CPU 11 uses a special C value, stored in advance in the flash memory 16, as an initial value. When the primary photographic subject is not present in the focus area, the photographer will perform a shutter release operation only after verifying that the primary photographic subject, having been outside the focus area, has entered the focus area. For this reason, the time point at which the photographer performs a shutter release operation under these circumstances tends to be delayed compared to the time point at which the photographer, recognizing that the primary subject is already present in the focus area, performs a shutter release operation. Data collected by conducting tests on numerous test subjects indicate that time points at which frames selected by most test subjects were obtained preceded the time points at which the corresponding full press operation signals were input from the full press switch 18b.

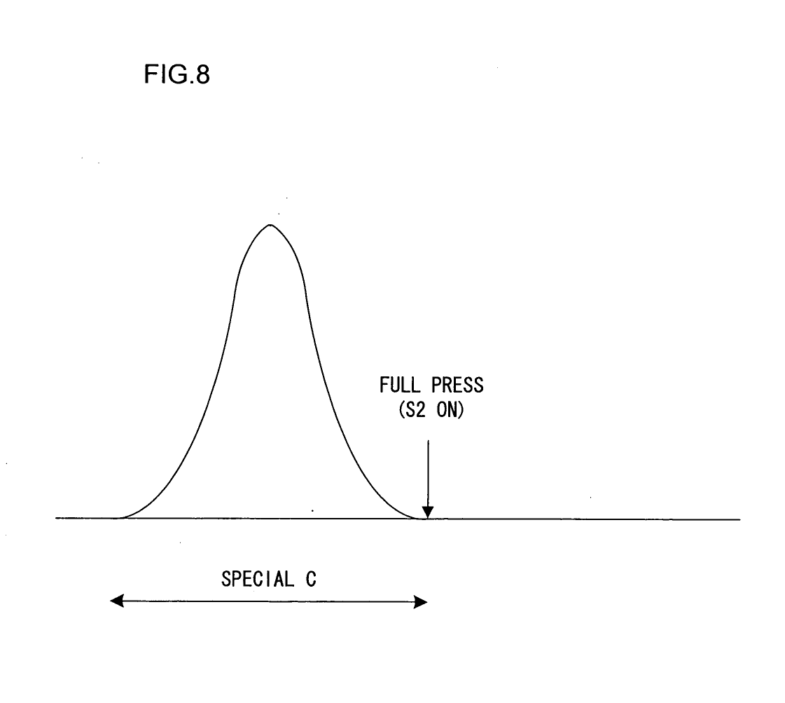

Accordingly, a value corresponding to the period preceding, for instance, the S2 ON timing, is selected as the special C value to be used when the focus lock is on and the primary subject is not present in the focus area, as shown in FIG. 8. The S2 ON timing is the time point at which the photographing instruction signal is issued. Since the entire range representing the special C value precedes the time point at which the photographing instruction signal is issued, special C=A (B=0) is true in the example presented in FIG. 8. By designating frame images obtained before the photographing instruction signal is issued as recording candidates, the probability of the desired image captured at intended instant, being included among the pre-capture images, obtained under conditions in which the shutter release operation timing tends to be delayed, can be improved.

(Variation 5)

When the focus lock is on, C′ obtained by subtracting a predetermined value (e.g., a value equivalent to 10 ms) from the C value used in the focus lock-off state may be used regardless of whether or not the primary subject is present in the focus area within the photographic image plane. When the focus lock is on, the focusing lens is not driven after the shutter release operation is performed, and accordingly, the predetermined value equivalent to the length of time required for the focusing lens drive is subtracted from the C value. By switching to the C′ value, which is smaller than the C value, the memory space used in the buffer memory can be reduced and the length of time required to transfer/record an image into the recording medium 30 can be reduced as well.

### Fourth Embodiment

In the fourth embodiment, the Δt values stored in the flash memory 16 are divided into separate groups based upon a specific criterion and a new value for C is calculated based upon the Δt values in a specific group selected from the plurality of groups formed through the grouping process. The main CPU 11 may detect any displacement of the primary subject and execute the grouping operation in correspondence to the displacement velocity of the subject, displacement of which has been detected.

(Displacement Velocity Within the Photographic Image Plane)

The subject displacement velocity may be calculated based upon, for instance, the displacement detected within the photographic image plane. In such a case, the main CPU 11 generates characteristics quantity data based upon the image data corresponding to a tracking target subject T within a captured image and uses reference data including the characteristics quantity data for purposes of template matching executed to track the tracking target subject T.

The main CPU 11 executes template matching processing of the known art by using image data expressing images in a plurality of frames obtained at varying time points so as to detect (track) an image area in a set of image data obtained later, which is similar to the tracking target subject T in a set of image data obtained earlier.

If the relative distance between the position of the area detected in the image data obtained later and the position of the target subject T in the image data obtained earlier exceeds a predetermined difference value, the main CPU 11 designates the quotient calculated by dividing the number of pixels representing the relative distance by the difference between the time points at which the frame images being compared were obtained ( 1/120 sec at 120 fps) as an image plane displacement velocity.

The main CPU 11 groups the Δt values stored in the flash memory 16 into categories corresponding to image plane displacement velocities calculated as described above. By storing each Δt value into the flash memory 16 in correlation with the data indicating the corresponding image plane displacement velocity, the main CPU 11 is able to group the Δt values stored in the flash memory 16 in correspondence to the image plane displacement velocities.

If it is decided in step S1 that a halfway press operation has been performed during the pre-capture photographing processing in FIG. 3, the main CPU 11 engages the image sensor 22 in operation to obtain a monitor image referred to as a live-view image, before proceeding to step S2. The monitor image in this context refers to an image captured by the image sensor 22 at a predetermined frame rate (e.g., 120 fps). The main CPU 11 calculates the image plane displacement velocity of the tracking target subject T by executing, as it does in conjunction with capture images, the template matching processing described earlier with the monitor image data expressing a plurality of frame images obtained at different time points.

When setting the initial values in step S2 (see FIG. 3) during the pre-capture photographing processing, the main CPU 11 selects the group made up with Δt values in a velocity range into which the image plane displacement velocity falls. It is assumed that the Δt values stored in the flash memory 16 will have been divided into a plurality of groups in advance based upon image plane displacement velocities. The main CPU 11 then calculates an average value ΔTmg of the Δtg values belonging to the selected group among the Δt values stored in the flash memory 16. The main CPU 11 subsequently updates the C value by designating the range defined by ±3σ relative to the average value ΔTmg as a new C value. All other aspects of the processing are identical to those of the second embodiment described earlier.

(Velocity of Displacement Along the Optical Axis)

The displacement velocity of a tracking target subject that repeatedly moves closer to and then further away from the electronic camera may be calculated based upon the extent to which the focusing lens is driven. For instance, the main CPU 11 may designate the quotient calculated by dividing the focusing lens drive quantity by the lens drive time (e.g., 1/30 sec) as the displacement velocity along the optical axis.

Through the fourth embodiment described above, the range of variance can be reduced compared to the variance manifesting when the number of frame images C is set without grouping the Δt values stored in the flash memory 16. Since the range of the new C value calculated based upon the narrower variance will also be narrower, an unnecessarily large value will not be set as the number of frame images C. Consequently, the memory space used in the buffer memory will be reduced and the length of time required to transfer/record the image into the recording medium 30 will also be reduced.

(Variation 6)

The grouping process may be performed through a method other than the subject displacement velocity-based grouping method. For instance, the main CPU 11 may perform the grouping process based upon the time of day at which photographic images are captured, based upon whether the photographic image is photographed with a longitudinal orientation or a lateral orientation or based upon whether or not the focus lock described earlier is on during the photographing operation.

The above described embodiments are examples, and various modifications can be made without departing from the scope of the invention.

What is claimed is:

1. An imaging apparatus, comprising:
an instruction unit that issues a photographing instruction signal;
an image sensor that obtains frame images over predetermined time intervals;
a storage unit in which a plurality of the frame images obtained via the image sensor are sequentially stored;
a save candidate determining unit that designates, among the plurality of the frame images stored in the storage unit, a plurality of the frame images obtained before and after an issue of the photographing instruction signal as candidates of images to be saved into a recording medium; and
a candidate number determining unit that automatically determines, based upon specific information, a candidate number of the frame images that are to be designated as candidates by the save candidate determining unit.

2. An imaging apparatus according to claim 1, further comprising:
an operation member that accepts an operation performed to select a specific frame image among the plurality of frame images designated as candidates of images to be saved, wherein:
the candidate number determining unit determines the candidate number of the frame images to be designated as candidates by using, as the specific information, a difference between time point at which the photographing instruction signal is received and time point at which the specific frame image is obtained.

3. An imaging apparatus according to claim 2, wherein:
the candidates of images to be saved are made up with A sheets of the frame images obtained before the issue of the photographing instruction signal and B sheets of the frame images obtained as and after the issue of the photographing instruction signal;
the imaging apparatus further comprises a save unit in which history of the difference between the time point at which the photographing instruction signal is received and the time point at which the specific frame image is obtained is saved; and
the candidate number determining unit determines the candidate number of the frame images obtained before the issue of the photographing instruction signal based upon an average value of timing differences indicated in the history saved in the save unit.

4. An imaging apparatus according to claim 2, wherein:
the candidate number determining unit executes analysis to determine a photographic scene based upon the frame images obtained before the issue of the photographing instruction signal and determines the candidate number of the frame images to be designated as candidates in correspondence to each photographic scene indicated in analysis results used as the specific information.

5. An imaging apparatus according to claim 1, wherein:
the candidates of images to be saved are made up with A sheets of the frame images obtained before the issue of the photographing instruction signal and B sheets of the frame images obtained as and after the issue of the photographing instruction signal; and
the candidate number determining unit ascertain frame-to-frame subject displacement based upon the A sheets of the frame images and reduces the candidate number so as to assume a smaller value as a sum of A and B in correspondence a smaller extent of the displacement indicated in displacement information used as the specific information.

6. An imaging apparatus according to claim 5, wherein:
the candidate number determining unit increases the candidate number so as to assume a greater value as the sum of A and B in correspondence to a greater extent of the frame-to-frame subject displacement.

7. An imaging apparatus according to claim 6, wherein:
the candidate number determining unit determines the candidate number so as to increase a ratio of A to the sum of A and B in correspondence to a greater extent of the frame-to-frame subject displacement.

8. An imaging apparatus according to claim 5, wherein:
when a remaining capacity available at the storage unit is equal to or less than a predetermined value, the candidate number determining unit reduces the candidate number so as to assume an even smaller value as the sum of A and B in correspondence to a smaller extent of the frame-to-frame subject displacement.

9. An imaging apparatus according to claim 2, further comprising:
a save unit in which history of the difference between the time point at which the photographing instruction signal is received and the time point at which the specific frame image is obtained is saved, wherein:
the candidate number determining unit determines the candidate number of the frame images based upon an average value and a variance value regarding the history saved in the save unit.

10. An imaging apparatus according to claim 9, further comprising:
a decision-making unit that makes a decision as to whether a photographing operation is being executed by holding a focus-adjusted state in which focus is adjusted on a subject present over a specific distance from the imaging apparatus, wherein:
the candidate number determining unit adjusts the candidate number of the frame images based upon results of the decision made by the decision-making unit.

11. An imaging apparatus according to claim 10, wherein:
when the decision-making unit decides that the photographing operation is being executed by holding the focus-adjusted state and a primary subject is not present within a focus area, the candidate number determining unit selects a preset value for a candidate number instead of the candidate number of the frame images having been determined.

12. An imaging apparatus according to claim 9, further comprising:
a grouping unit that divides values saved as the history in the save unit into groups, wherein:
the candidate number determining unit determines the candidate number of the frame images based upon an average value and a variance value regarding history belonging to a group having been formed via the grouping unit.

13. An imaging apparatus according to claim 12, further comprising:
a velocity detection unit that detects a displacement velocity of a primary subject, wherein:
the grouping unit divides the history saved in the save unit into groups in correspondence to displacement velocities; and
the candidate number determining unit determines the candidate number of the frame images based upon an average value and the variance value regarding the history belonging to a group corresponding to the displacement velocity.
